(19) United States
(12) Patent Application Publication
(10) Pub. No.: US 2012/0109619 A1
(43) Pub. Date: May 3, 2012

(54) GENERATING A RESOURCE MANAGEMENT PLAN FOR AN INFRASTRUCTURE

(76) Inventors: Daniel Juergen Gmach, Palo Alto, CA (US); Cullen E. Bash, Los Gatos, CA (US); Jerome Rolia, Kanata (CA); Yuan Chen, Sunnyvale, CA (US); Thomas W. Christian, Fort Collins, CO (US); Amip J. Shah, Santa Clara, CA (US); Ratnesh Kumar Sharma, Fremont, CA (US); Zhikui Wang, Fremont, CA (US)

(21) Appl. No.: 12/916,292

(22) Filed: Oct. 29, 2010

(51) Int. Cl. G06G 7/62

(52) U.S. Cl. 703/21

(57) ABSTRACT

In a method for generating a resource management plan for an infrastructure, a resource supply available from a combination of resource sources is determined, an operation of the infrastructure in performing an objective using the determined supply of resources is simulated, in which the simulation is to simulate resource demand of a plurality of infrastructure components in performing the objective, a metric(s) associated with operating the infrastructure based upon the simulation is determined, a determination as to whether the metric(s) satisfies a predetermined goal(s) is made, the resources supplied and/or the simulation of the resource demand of the plurality of infrastructure components is modified in response to the at least one metric failing to satisfy the predetermined goal(s), and a resource management plan for the infrastructure that has been determined to result in the metric(s) satisfying the predetermined goal(s) is generated.

### CROSS-REFERENCE TO RELATED APPLICATION

The present disclosure contains some common subject matter with co-pending and commonly assigned U.S. patent Ser. No. 12/915,212, entitled “Managing an Infrastructure”, filed on Oct. 29, 2010, the disclosure of which is hereby incorporated by reference in its entirety.

### BACKGROUND

It is estimated that the information and communication technology sector (ICT) is responsible for 2% of global energy use and carbon emissions. Much of this is due to the energy consumption of data centers. Significant research is underway to develop technologies that reduce energy use and the environmental impact of data centers. On the demand side, virtualization technology is being used to consolidate workload and facilitate information technology (IT) utilization and reduce IT power consumption. Cooling technologies, such as, air-side economizers, and the direct use of outside air further help facilitate data center cooling efficiency. On the supply side, renewable energy and distributed power supply management are being developed to reduce environment impact and cost.

However, the joint behavior of these technologies in an integrated supply demand context is difficult to determine. In particular, the interaction of the technologies with each data center's unique workloads is difficult to determine.

### BRIEF DESCRIPTION OF DRAWINGS

Features of the present disclosure are illustrated by way of example and not limited in the following figure(s), in which like numerals indicate like elements, in which:

FIG. 1 illustrates a simplified block diagram of an infrastructure management apparatus, according to an example of the present disclosure;

FIG. 2 illustrates a method of managing an infrastructure, according to an example of the present disclosure; and

FIG. 3 illustrates a block diagram of a computing apparatus configured to implement the method depicted in FIG. 2, according to example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on.

Disclosed herein are apparatuses and methods for generating a resource management plan for an infrastructure having infrastructure components. The infrastructure components may include information technology (IT) equipment, such as, but not limited to servers, network switches, routers, firewalls, intrusion detection systems, intrusion prevention systems, hard disks, monitors, power supplies, and other components typically found in computer networking environments. The infrastructure may also include facility equipment, such as, but not limited to facility power supply equipment, air conditioning systems, air moving systems, water chillers, and other equipment typically found in operating computer networking environments. In one regard, the infrastructure comprises at least one computer room or container, such as, but not limited to an IT data center that houses the infrastructure components. In addition, throughout the present disclosure, the term “managing” is intended to encompass either or both of designing and operating the infrastructure.

The apparatuses and methods disclosed herein are to generate a resource management plan for an infrastructure through an integrated analysis of the resource supply side and the resource demand side of the infrastructure. The integrated analysis includes the evaluation of multiple resource supply side and resource demand side design alternatives, as well as multiple infrastructure component and facilities management policies to enable the evaluation and comparison of various alternative approaches to supply the infrastructure with resources. In one regard, the integrated analysis may be employed to identify a combination of the infrastructure component operations and the supply of resources that substantially meets at least one predetermined goal, such as, total cost of ownership, carbon emission levels, reliance upon grid level resources, maximizes renewable resource usage, etc. More particularly, a plurality of combinations may be evaluated to identify a substantially optimized combination.

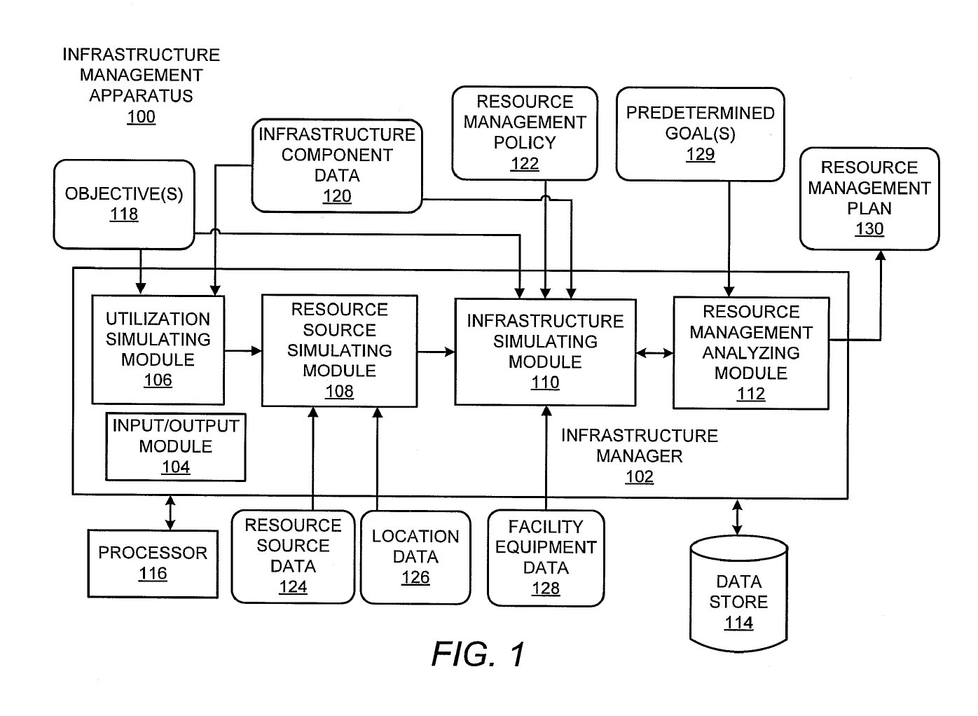

With reference first to FIG. 1, there is shown a simplified block diagram of an infrastructure management apparatus 100, according to an example. The infrastructure management apparatus 100 is depicted as including an infrastructure manager 102, a data store 114, and a processor 116. It should be understood that the infrastructure management apparatus 100 may include additional elements and that some of the elements described herein may be removed and/or modified without departing from a scope of the infrastructure management apparatus 100.

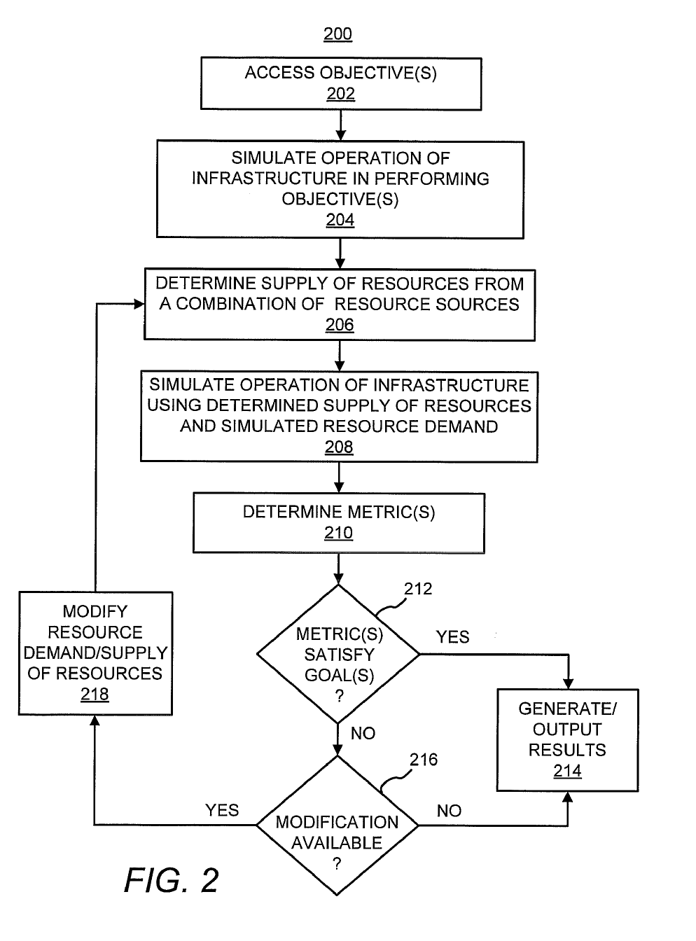

The infrastructure manager 102 is depicted as including an input/output module 104, a utilization simulating module 106, a resource source simulating module 108, an infrastructure simulating module 110, and a resource management analyzing module 112. Various manners in which the modules 104-112 operate are discussed in detail herein with respect to the method 200 depicted in FIG. 2.

According to an example, the infrastructure manager 102 comprises machine readable instructions stored, for instance, in a volatile or non-volatile memory, such as DRAM, EEPROM, MRAM, flash memory, floppy disk, a CD-ROM, a DVD-ROM, or other optical or magnetic media, and the like. In this example, the modules 104-112 comprise modules with machine readable instructions stored in the memory, which are executable by a processor of a computing device. According to another example, the infrastructure manager 102 comprises a hardware device, such as, a circuit or multiple circuits arranged on a board. In this example, the modules 104-112 comprise circuit components or individual circuits, which the processor 116 may also control. According to a further example, the infrastructure manager 102 comprises a combination of modules with machine readable instructions and hardware modules. In addition, multiple processors may be employed to implement or execute the infrastructure manager 102.

The infrastructure management apparatus 100 may comprise a computing device and the infrastructure manager 102 may comprise an integrated and/or add-on hardware device of the computing device. As another example, the infrastructure manager 102 may comprise a computer readable storage device upon which machine readable instructions for each of the modules 104-112 are stored and executed by the processor 116.

Generally speaking, the infrastructure manager 102 is to support the generation design of a resource management plan that matches the supply of resources with the demand for resources in an infrastructure, such as, an information technology data center. A resource management plan may include a choice for peak grid power, a mix of renewable resource sources, resource storage, and infrastructure component resource management policies. The resource management plan may define a set of constraints for the infrastructure based on a combination of metrics such as, but not limited to, QoS requirements, central processing unit (CPU) violation penalties for hosted workloads, environmental impact, energy consumption, and other metrics associated with operating the infrastructure. The infrastructure manager 102 may integrate resource demand and resource supply to satisfy the defined set of constraints during design and, apply resource management policies to satisfy the defined set of constraints during operation of the infrastructure. The infrastructure manager 102 may perform these functions by evaluating the impact of alternative resource management policies on time varying power supply needs during infrastructure operation.

The infrastructure manager 102 may identify a provisioning of resources, for instance, from a utility grid or from a mix of local generation or storage resources, that substantially minimizes capital, amortization and maintenance costs. Additionally, the infrastructure manager 102 may provide enhanced service quality by reducing resource supply shortages and the demand constraints that result from the resource supply shortages. Further, through integration of resource supply and resource demand, the infrastructure manager 102 increases the probability of meeting higher level constraints, such as, but not limited to infrastructure sustainability or operational cost.

The infrastructure manager 102 may generate a resource management plan by determining a mix of resource supplies, including a resource storage device, and manipulating that mix to match resource demand and meet at least one predetermined goal, such as, but not limited to, application QoS requirements, reduce emissions and, in certain instances, reduce dependence on grid level power. Additionally, the infrastructure manager 102 may manipulate resource demand in order to meet limitations in the supply-side delivery capacity. Further, the infrastructure manager 102 may evaluate the impact of the defined set of constraints, and adjust one or both of the resource demand and the resource supply to substantially ensure that the output of the infrastructure falls within the defined set of constraints.

According to an example, the infrastructure manager 102 receives a resource management policy 122 and other data from the user through the input/output module 104 and may store the data in the data store 114. The infrastructure manager 102 may, however, obtain this information through alternative sources, such as, but not limited to, the data previously stored in the data store 114. As shown in FIG. 1, the other data may include at least one objective 118, infrastructure component data 120, resource source data 124, location data 126, facility equipment data 128, predetermined goal(s) 129, etc. The objective(s) 118 may comprise workloads that are likely to be performed by the infrastructure components based upon historical data and/or future demand determinations. The resource management policy 122 may comprise various policies, such as, but not limited to, server power capping, in which dynamic processor frequencies or power states to adjust power used by servers, pool power capping, in which the number of servers used to perform the objective 118 is dynamically varied based on the availability of resources, use of virtual machine technology, provisions set forth in one or more service level agreements (SLAs), placement of workloads on selected servers, placement of workloads on servers located in selected areas of the infrastructure, etc.

The infrastructure component data 120 may comprise, for instance, data pertaining to the types and placements of infrastructure components installed in an existing infrastructure, data pertaining to available types of infrastructure component and facility equipment that may be installed in a future or existing infrastructure, etc. Thus, for instance, the infrastructure component data 120 may specify that the infrastructure has or is likely to have a particular number of one or more types of servers, a particular number of one or more types of network switches, etc.

The resource source data 124 comprises data pertaining to one or more resource sources for the infrastructure, which may include, for instance, photovoltaic panels, solar thermal power sources, municipal solid waste facilities, fuel cells, wind turbines, the electrical grid, etc. Thus, for instance, the resource source data 124 may include information pertaining to at least one available resource source from which an existing infrastructure receives resources or a future infrastructure may receive resources.

The location data 126 comprises data pertaining to the physical location or environment in which the infrastructure is located or is likely to be located. Thus, for instance, the location data 126 may indicate the average outside temperature over various periods of time, the average wind speeds over various periods of time, the amount of sun light available over various periods of time, etc.

The facility equipment data 128 may specify that the infrastructure has or is likely to have a particular number of one or more types of air conditioning units, a particular number of water chillers, a particular number and placement of one or more types of ventilation tiles, etc. The facility equipment data 128 may also comprise data pertaining to an existing cooling solution in use in an existing infrastructure or to an available cooling solution that may be used to replace and/or augment the existing cooling solution. The available cooling solutions may include, for instance, the use of computer room air conditioning (CRAC) units, chillers, cooling towers, the use of underground heat exchangers, outside air cooling, etc.

The data store 114 comprises volatile or non-volatile memory, such as, but not limited to dynamic random access memory (DRAM), electrically erasable programmable read-only memory (EEPROM), magnetoresistive random access memory (MRAM), Memristor, flash memory, floppy disk, a compact disc read only memory (CD-ROM), a digital video disc read only memory (DVD-ROM), or other optical or magnetic media, and the like. In any regard, the modules 106-112 may retrieve data from the data store 114 in performing their respective operations. Although the data store 114 has been depicted as forming a separate component from the infrastructure manager 102, it should be understood that the data store 114 may be integrated with the infrastructure manager 102 without departing from a scope of the infrastructure management apparatus 100. In this regard, the data store 114 may comprise a memory device located on the same circuit as the infrastructure manager 102 or may comprise a memory location of the computer readable medium upon which the machine readable instructions of the infrastructure manager 102 are stored.

Various manners in which the modules 104-112 of the infrastructure manager 102 may operate in generating a resource management plan for an infrastructure are discussed with respect to the method 200 depicted in FIG. 2. FIG. 2, according to an example. It should be readily apparent that the method discussed below with respect to FIG. 2 represents a generalized illustration and that other processes may be added or existing processes may be removed, modified or rearranged without departing from a scope of the method 200.

Although particular reference is made to the infrastructure management apparatus 100 depicted in FIG. 1 as performing the method 200, it should be understood that the method 200 may be performed by a differently configured apparatus without departing from a scope of the method 200.

At block 202, at least one objective 118 that is performable by the infrastructure components in the infrastructure is accessed, for instance through the input/output module 104. The objective(s) 118 may be based upon, for instance, historical data and/or future objective determinations. In any regard, the objective(s) 118 may be accessed through receipt of the objective(s) 118 from a user input, through access of the information stored on the data store 114, or through other sources.

At block 204, the utilization of infrastructure components in performing the objective(s) 118 is simulated, for instance, by the utilization simulating module 106. More particularly, for instance, the utilization simulating module 106 may simulate the placement of the objective(s) 118 on one or more infrastructure components, in which, the placement is based upon a set of constraints. The set of constraints may include, for instance, the capabilities of the infrastructure components to perform the objective(s) 118, the capabilities of cooling systems to cool the infrastructure components, the provisions set forth in the management policies 122, etc. The utilization simulating module 106 may also simulate the utilization of the infrastructure components while ensuring that the utilizations meet provisions contained in one or more service level agreements (SLAs). The utilization simulating module 106 may further simulate the utilization of the infrastructure components without implementing a power capping scheme to thereby determine a normal resource demand of the infrastructure components.

The utilization simulating module 106 may simulate the placement of the objective(s) 118 onto the infrastructure components to substantially maximize efficiency, for instance, by consolidating the objective(s) 118 onto a substantially minimized number of infrastructure components. In addition, the utilization simulating module 106 may also simulate infrastructures having substantially minimized sizes and substantially minimized average and peak resources used to perform the objective(s) 118. Moreover, the objective(s) 118 may include applications that place complex information technology (IT) resource demands on the infrastructure components, such as, but not limited to, servers. For example, many enterprise applications operate continuously, have unique time varying demands, and have performance-oriented QoS objectives. To evaluate which of the applications and corresponding workloads (objective(s) 118) may be consolidated to particular servers, the utilization simulating module 106 may perform preliminary performance and workload analysis. By way of example, the utilization simulating module 106 uses a trace based approach to determine which of the workloads may be consolidated to which servers. The trace based approach assesses permutations and combinations of workloads (objective(s) 118) in order to determine a substantially optimal workload placement that provides specific QoS for applications. The trace based approach takes into account the benefits of resource sharing for complementary workload patterns and thereby substantially limits resource over-provisioning. Alternately, the utilization simulating module 106 may estimate the peak resource requirements of each job in the objective(s) 118 and then evaluate the combined resource requirements of the objective(s) 118 by using the sum of the peak demands of each job in the objective(s) 118. As a further alternative, the utilization simulating module 106 may evaluate the combined resource requirements of the objective(s) 118 by using the sum of some percentile, such as, for instance, the 100^{th}-percentile, the 99^{th}-percentile, etc.

The trace-based simulation of the performance of the objective(s) 118 may comprise historical traces that may be used to capture past application resource demand, for instance, CPU, memory, and input-output usage, that may be representative of future application behavior. The utilization simulating module 106 may use the historical traces to evaluate the impact of different management policies 122. By way of example, the historical traces comprise resource demands determined at 5 minute intervals over a month of collecting data. The utilization simulating module 106 may use the historical traces to determine an initial placement of workloads (objectives 118) on the servers. In addition, or alternatively, the trace-based simulation may comprise synthetic traces that reflect expected demands for planning purposes.

In addition, or alternatively, in designing an infrastructure, the utilization simulating module 106 may also simulate various infrastructure components. Thus, for instance, the utilization simulating module 106 may perform a first simulation involving a first plurality of infrastructure components to perform the objective(s) 118, a first plurality of facility equipment associated with utilization of the first plurality of infrastructure components, under a first management policy. The utilization simulating module 106 may vary one or more of the infrastructure components, facility equipment, and the management policy in performing subsequent simulations upon receipt of directions determined by the resource management analyzing module 112 at block 218 hereinbelow.

In one regard, therefore, the utilization simulating module 106 provides time-varying information on the requirements of the infrastructure components to perform the objective(s) 118, the utilization values of the Infrastructure components in performing the objective(s) 118, QoS metrics associated with performing the objective(s) 118, substantially ensures that SLAs are being met, etc.

The utilization simulating module 106 may determine the resource demand for the infrastructure associated with the simulated utilization of the infrastructure components. More particularly, for instance, the utilization simulating module 106 may determine the aggregate resource demand of the infrastructure to perform the objective(s) 118 as a function of time, since the resource demand may vary, for instance, on the time of day at which the infrastructure components are performing the objective(s) 118. By way of example, outside air may be used to supplement cooling at night, which may reduce the amount of resources used to operate the cooling systems.

According to an example, in which the infrastructure components comprise servers, the utilization simulating module 106 determines each of the servers' power consumption within the trace based approach. More particularly, the utilization simulating module 106 may simulate placement of the workload (objective(s) 118) and server utilization over time using the following linear power model:

Pₛₑᵣᵥₑᵣ=P_{idle}+u*(P_{full}−P_{idle}), Eqn (1)

in which P_{idle} is the idle power of the server and P_{full} is the power consumption of the server when it's fully utilized. u represents the CPU utilization of the server as a percentage.

The utilization simulating module 106 determines a total resource demand of the infrastructure components by summing the resource demand per infrastructure component. As noted in Eqn (1), the power consumption of each of the servers, with the addition of the networking switches, is considered as resulting in a total IT equipment power consumption. As this equation does not consider all of the other equipment, such as, hard drives, monitors, power supplies, etc., contained in the infrastructure, the equation may be calibrated to more closely model actual resource demands of the IT equipment through use of historical data or experiments.

In order to determine the aggregate resource demand of the infrastructure, the utilization simulating module 106 may also determine the resource demands of the facility equipment, including the resource distribution infrastructure and the cooling infrastructure of the infrastructure. According to an example, the utilization simulating module 106 may determine the aggregate resource demand using a power usage effectiveness (PUE) metric, which is a ratio of the total power used by the infrastructure to the power used by the infrastructure components, such as, the IT equipment, itself. The PUE represents the additional power consumption by the facility equipment, the power distribution infrastructure, and the cooling infrastructure. The resource source modeling module 108 may estimate the PUE from simulation or through historically averaged data for similar infrastructure solutions.

At block 206, a supply of available resources by a combination of available resource sources is determined, for instance, by the resource source simulating module 108. Thus, by way of example, the resource source simulating module 108 may determine the resource supply produced by one or more combinations of resource sources. In addition, the resource source simulating module 108 assesses different resource supply solutions based upon the location data 126 and the resource source data 124 in determining the available resource supply from a combination of available resource sources. More particularly, for instance, the resource source simulating module 108 assesses location data, climate information, and various resource supply solutions. The location data 126 may include, for instance, the length of time during the day that sunlight is available, the average wind speeds, etc., of the infrastructure location. The various resource supply solutions may include, for instance, photovoltaic panels, wind turbines, municipal solid waste power plants, tidal power, and other renewable energy sources, as well as the electrical grid.

According to an example, the resource source simulating module 108 is to simulate time-varying traces for the determined resource supply to the infrastructure for various combinations of the resource sources. The time-varying traces generally capture the impact of geographical and climate characteristics for the locations either considered for the infrastructure or the location of an existing infrastructure. In addition to the traces, the resource source simulating module 108 may determine statistical meta data as the mean and variability of resource supply, that is, the resource changes between consecutive measurement intervals. The resource source simulating module 108 may consider the resource changes between consecutive measurement intervals because they describe how flexible and fast the infrastructure is to be to adapt to changes in resource supply. In addition, the resource source simulating module 108 may provide data that may be used to evaluate different combinations of resource supply during the infrastructure design phase to assist in finding the most cost-effective and sustainable supply solution for the infrastructure.

At block 208, operation of the infrastructure is simulated using the determined resource demand and the determined supply of resources, for instance, by the infrastructure simulating module 110. More particularly, for instance, the infrastructure simulating module 110 may perform an integrated analysis of the resource demand determined at block 204 and the contributions of multiple available resource sources determined at block 206.

According to an example, the infrastructure simulating module 110 simulates the performance of the infrastructure components operating under the determined resource demand, the determined supply of resources and a resource management policy 122. The resource management policy 122 may include, for instance, policies for server power capping and pool power capping as described hereinbelow. In one regard, the infrastructure simulating module 110 determines the effect of time varying supply of resources and limits on peak resources available from an electrical grid, and the impact of resource storage, on the simulated operation of the infrastructure. The infrastructure simulating module 110 may perform the simulation for representative resource supply traces to evaluate a wide range of resource supply conditions, resource management policies, and their resulting impact.

In addition, the infrastructure simulating module 110 may use additional trace data to simulate the behavior of the infrastructure. More particularly, for instance, the infrastructure simulating module 110 may use the trace data from a migration controller (not shown) to determine when servers are overloaded or underutilized, for instance, through use of a migration controller (not shown).

The infrastructure simulating module 110 may use the trace data resulting from the migration controller migrating workloads from heavily utilized servers to more lightly utilized servers to better satisfy workload resource access QoS constraints. The migration controller may migrate workloads without interrupting the execution of the corresponding applications, determine whether additional servers are to be used to satisfy resource access QoS constraints, and/or whether servers may be removed without affecting such constraints. The infrastructure simulating module 110 measures and reports on resulting resource usage and resource access QoS statistics for the objective 118.

The infrastructure simulating module 110 may also use the trace data to determine the impact of various management policies. However while the consolidation aspects of the trace based approach reduce the resources used to support the objective(s) 118, the trace based approach manages the infrastructure components with respect to application performance behavior and not with respect to available resources. Moreover, the infrastructure simulating module 110 may provide time-varying information on the requirements of the infrastructure components to perform the objective(s) 118, the utilization values of the infrastructure components in performing the objective(s) 118, QoS metrics associated with performing the objective(s) 118, substantially ensures that SLAs are being met, etc.

According to an example, the infrastructure simulating module 110 may measure all workload and resource demands on all servers using, for instance, a central server resource coordinator. In instances in which an aggregate resource demand for the infrastructure components exceeds a threshold, the utilization may be scaled back equally on all of the servers until the threshold for aggregate resource usage is satisfied. The infrastructure simulating module 110 may implement server power capping based upon coordination among the servers, in which no server constrains its workloads more than necessary.

The infrastructure simulating module 110 may implement an additional parameter for server resource capping to limit the effect of the server resource capping. For instance, the infrastructure simulating module 110 may restrict the impact of the dynamic frequency scaling to a predetermined percentage of total workload demand on a server, for instance, the total workload demand on a server is reduced up to about 10% or 50%. The additional parameter protects the workloads from being starved for capacity and generating an increasing backlog of unsatisfied demand. For instance, a CPU scheduler (not shown) employed by the infrastructure simulating module 110 may determine a fraction of resource demands that is to be satisfied for each interval. Any unsatisfied demands are carried forward to the next interval. Additionally, the CPU scheduler may allocate CPU cycles to workloads based on a weight and capping factor.

The infrastructure simulating module 110 may permit violations to the resource budget if workload resource demands become starved for capacity. This may result in a resource deficit. The infrastructure simulating module 110 may determine that the resource management plan is invalid in instances in which the resource deficit is too large for a simulation. Alternately, the infrastructure simulating module 110 may implement server power capping by reducing the workload demand through admission control or stopping the execution of applications.

According to another example, the infrastructure simulating module 110 simulates the infrastructure operation under a resource management policy of pool power capping. Pool power capping controls the servers in the infrastructure. For instance, pool power capping may affect the resource demand of the server pool by controlling the number of servers used. For example, the infrastructure simulating module 110 may continuously monitor the overall power consumption of the server pool in addition to server utilization, using for instance, the migration controller. In instances in which the pool power consumption approaches the peak grid limit, the migration controller may attempt to further consolidate workloads and shut down at least one of the servers. The infrastructure simulating module 110 performs pool power capping by identifying the least loaded server and attempting to migrate the workloads of the least loaded server to the remaining servers.

The migration of a workload to a remaining server may be permitted in instances in which there are sufficient memory resources on the server to support all of the workloads on that server, including workloads that are to be migrated from the least loaded server. CPU resources may be permitted to be over booked. In instances in which the remaining servers having sufficient memory resources, the migration controller may direct migration of the workloads on the server to the remaining servers and shut down the server after the workloads have been migrated. This enables the remaining servers to increase their resource budgets. Additionally, the infrastructure simulating module 110 may direct the migration controller to add servers in instances where there is sufficient resources available. Pool power capping may be complemented by server power capping to more effectively bound resource usage.

According to another example, the infrastructure simulating module 110 modifies the supply of resources to include and/or increase a supply of resources from the resource storage device. For instance, the infrastructure simulating module 110 may simulate use a resource storage device to store and smooth the supply resources to the infrastructure. The resource storage device may include, for instance, flywheels, batteries, etc. For example, for each interval in the simulation, in instances when the sum of renewable and available grid power exceeds the resource demand, surplus resources may be added to the resource storage device. The infrastructure simulating module 110 may also determine a maximum size of resource storage for each simulation and may perform the simulation using the maximum size of resource storage.

At block 210, at least one metric is determined, for instance, by the resource management analyzing module 112. The at least one metric may comprise at least one of acquisition costs, operational costs, sustainability metrics, resource access quality such as but not limited to CPU violation penalties, QoS of the hosted application, etc. The sustainability metrics may include, for instance, embedded footprint, CO₂ emissions, water consumption, etc. The resource access quality metrics measure whether the resource demands of objectives are satisfied, and if not by how much the supply falls short of the demand. QoS metrics measure whether or not QoS objectives, such as, but not limited to application response time, have been met, and if not by how much they fall short. Thus, for instance, the infrastructure simulating module 110 may determine the at least one metric based upon various characteristics of the selected infrastructure components, the selected facilities equipment, as well as the selected mix of energy supply sources in the infrastructure. In addition, the resource management analyzing module 112 may perform the integrated analysis to determine the relationship as it varies over time.

At block 212, a determination as to whether the at least one metric satisfies the predetermined goal(s) 129 is made, for instance, by the resource management analyzing module 112. The predetermined goal(s) 129 may comprise, for instance, acquisition costs, operational costs, sustainability metrics, resource access quality, QoS of the hosted application, etc. In one particular example, the end user may be provided with a number options with respect to the goals, which the end user may select through an input source (not shown). The input source may comprise an interface device, such as, a keyboard, a mouse, or other input device.

According to an example, the metric determined at block 210 comprises a level of CPU violation penalties resulting from the simulated operation of the infrastructure at block 208 hereinabove. In this example, the resource management analyzing module 112 may determine whether the level of CPU violation penalties satisfies a predetermined goal 129 for the level of CPU violation penalties. The CPU violation penalty is a resource access quality metric that estimates the sustained impact of such resource deficits on application performance behavior, which may result when access to resources is limited. Resources may be unavailable because of spikes in workload demands, aggressive consolidation, or a drop in the supply of resources that leads to power capping. In any regard, the CPU violation penalty is based on the number of successive intervals in which a workload's demands are not fully satisfied and an expected impact on an end user of the applications hosted by the infrastructure, for instance a customer of an operator of the infrastructure. Longer epochs of unsatisfied workload demand incur greater penalty values, as these longer epochs are more likely to be perceived by the users of the applications.

By way of illustration, in instances in which service performance is degraded for up to 5 minutes, end users may be presumed to notice the degradation of service performance. In instances in which the service performance is degraded for more than 5 minutes, end users may start to contact the operator of the infrastructure to complain regarding the degradation of service performance. The quality of the delivered service depends on how significant the service performance is degraded. In instances in which resource demands greatly exceed allocated resources, then the utility of the service may suffer more than in instances in which resource demands are almost satisfied. Thus, for each violation, the CPU violation penalty provides a penalty weight based on the expected impact of the degraded quality on the end user.

The CPU violation penalty value for a violation with I successive overloaded measurement intervals is defined using:

pen=I²maxᵢ₌₁^{I}(w_{pen,i}), Eqn (2)

in which w_{pen,i} is a penalty in an ith interval. Longer violations therefore to incur greater penalties than shorter violations.

With regard to CPU allocations, the resource management analyzing module 112 may estimate the impact of degraded service on each end user using a heuristic that compares the actual and desired utilization of allocation for the end user. The resource management analyzing module 112 is estimated in instances in which measurements that reflect the actual impact on the end user are unavailable.

According to an example, uₐ and u_{d}<1 are an actual CPU utilization and desired CPU utilization of CPU allocation for an interval. In instances in which uₐ<u_{d} then the weight for the CPU penalty wₚₑₙ is defined as wₚₑₙ=0 because there is no violation. In instances in which uₐ>u_{d}, end-to-end response times are expected to be higher than desired. The resource management analyzing module 112 may estimate the impact of the degradation on the end user using:

$${w}_{pen} = 1 - \frac{1 - {u}_{a}^{k}}{1 - {u}_{d}^{k}} , \qquad Eqn ( 3 )$$

in which the penalty weight has a value between 0 and 1 and is larger for higher utilizations. The superscript k denotes the number of CPUs on the server. The resource management analyzing module 112 may use Eqn (3) to estimate the mean response time for a queue with processors and unit service demand. The power term k reflects the fact that a server with more CPUs can sustain higher utilizations without impacting end user response times. Similarly, an end user that has a higher than desired utilization of allocation is less impacted on a system with more CPUs than one with fewer CPUs.

In response to a determination that the metric(s) determined at block 210 satisfy the goal(s) 129, results may be outputted at block 214, for instance, by the resource management analyzing module 112. The resource management analyzing module 112 may output, for instance, the infrastructure components used in the simulation at block 204 as well as the supply of resources determined at block 206. The resource management analyzing module 112 may also output the resource management policy used in the simulation. The infrastructure components, the determined supply of resources, and the resource management policy comprise a resource management plan. In addition, the resource management analyzing module 112 may output the results to a computing device, a printer, a display, etc.

In response, however, to a determination that the metric(s) determined at block 210 do not satisfy the goal(s) 129 at block 212, the resource management analyzing module 112 may determine whether at least one other modification of at least one of the resource demand and the supply of resources is available as indicated at block 216. If no further modifications are available, for instance, following an analysis of all of the possible combinations of infrastructure component utilizations and resource supply mixes, the resource management analyzing module 112 may output a result at block 214 indicating that a combination of resource demand and resource supply that results in the metric(s) satisfying the goal(s) 129 has not been found.

However, if at least one additional modification is available, the resource management analyzing module 112 modifies at least one of the resource demand and the supply of resources as indicated at block 218. In addition, the processes identified by blocks 206-218 may be repeated for a number of iterations until one of: a modified combination of the resource demand and the supply of resources that results in the at least one metric satisfying the at least one predetermined goal is identified and a determination that no further modifications are available is made.

According to an example, multiple iterations of blocks 208-218 may be performed even in instances in which the metric(s) 118 has been determined to satisfy the goal(s) 129 until no further combinations of modifications are are determined to be available at block 216, for a predetermined number of iterations or time, etc. In this example, the multiple iterations may be performed to determine a mix of the resources supplied and the resource demand that results in a substantially optimized metric(s) 118. By way of example, the mix of the resources supplied and the resource demand that results in a substantially optimized metric(s) 118 comprises a mix of the resources supplied and the resource demand that results in a substantially minimized reliance upon resources supplied from nonrenewable resource sources while maximizing performance of the objective by the infrastructure components.

Some or all of the operations set forth in the method 200 may be contained as utilities, programs, or subprograms, in any desired computer accessible medium. In addition, the method 200 may be embodied by computer programs, which may exist in a variety of forms both active and inactive. For example, they may exist as machine readable instructions, including source code, object code, executable code or other formats. Any of the above may be embodied on a computer readable storage medium.

Example computer readable storage media include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

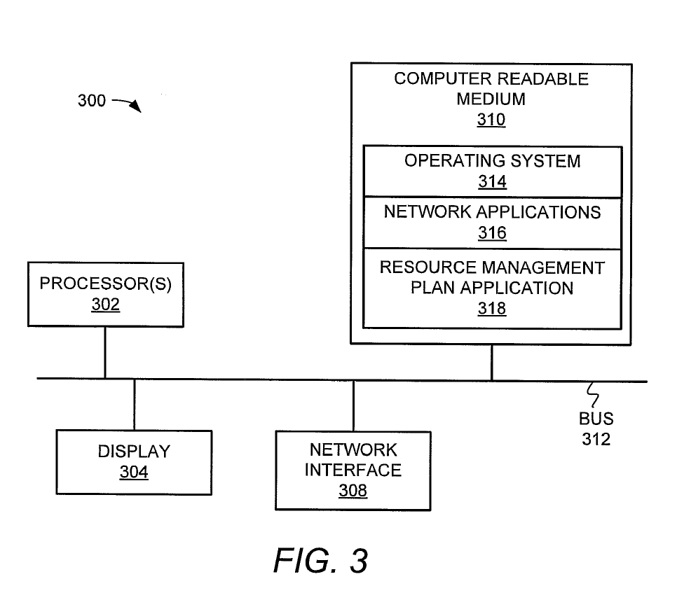

Turning now to FIG. 3, there is shown a schematic representation of a computing device 300 that may be used as a platform for implementing or executing the processes depicted in FIG. 2, according an example. The device 300 includes at least one processor 302, such as a central processing unit; at least one display device 304, such as a monitor; at least one network interface 308, such as a Local Area Network LAN, a wireless 802.11x LAN, a 3G mobile WAN or a WiMax WAN; and a computer-readable medium 310. Each of these components is operatively coupled to at least one bus 312. For example, the bus 312 may be an EISA, a PCI, a USB, a FireWire, a NuBus, or a PDS.

The computer readable medium 310 may be any suitable medium that participates in providing instructions to the processor 302 for execution. For example, the computer readable medium 310 may be non-volatile media, such as an optical or a magnetic disk; volatile media, such as memory; and transmission media, such as coaxial cables, copper wire, and fiber optics. Transmission media may also take the form of acoustic, light, or radio frequency waves. The computer readable medium 310 has been depicted as also storing other machine readable instruction applications, including word processors, browsers, email, Instant Messaging, media players, and telephony machine readable instructions.

The computer-readable medium 310 has also been depicted as storing an operating system 314, such as Mac OS, MS Windows, Unix, or Linux; network applications 316; and a resource management plan application 318. The operating system 314 may be multi-user, multiprocessing, multitasking, multithreading, real-time and the like. The operating system 314 may also perform basic tasks, such as recognizing input from input devices, such as a keyboard or a keypad; sending output to the display 304 and the design tool 306; keeping track of files and directories on medium 310; controlling peripheral devices, such as disk drives, printers, image capture device; and managing traffic on the at least one bus 312. The network applications 316 include various components for establishing and maintaining network connections, such as machine readable instructions for implementing communication protocols including TCP/IP, HTTP, Ethernet, USB, and FireWire.

The resource management plan application 318 provides various components with machine readable instructions for providing computing services to users, as described above. In certain examples, some or all of the processes performed by the application 318 may be integrated into the operating system 314. In certain examples, the processes may be at least partially implemented in digital electronic circuitry, or in computer hardware, machine readable instructions (including firmware and/or software) or in any combination thereof.

What has been described and illustrated herein are various examples of the disclosure along with some of their variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for generating a resource management plan for an infrastructure, said method comprising:
a) determining a supply of resources available from a combination of available resource sources;
b) simulating, using a processor, an operation of the infrastructure in performing an objective using the determined supply of resources, wherein the simulation is to simulate resource demand of a plurality of infrastructure components in performing the objective;
c) determining at least one metric associated with operating the infrastructure based upon the simulation;
d) determining whether the at least one metric satisfies at least one predetermined goal;
e) modifying at least one of the resources supplied by the combination of available resource sources and the simulation of the resource demand of the plurality of infrastructure components in response to the at least one metric failing to satisfy the at least one predetermined goal; and
f) generating a resource management plan for the infrastructure that includes a mix of the resources supplied and the resource demand that have been determined to result in the at least one metric satisfying the at least one predetermined goal.

2. The method according to claim 1, further comprising:
repeating b)-f) until one of:
a modified mix of the resources supplied and the resource demand that have been determined to result in the at least one metric satisfying the at least one predetermined goal is identified at d); and
a determination that no further modifications are available is made.

3. The method according to claim 2, further comprising:
outputting results pertaining to one of the generated resource management plan and that identification of a combination of the resource demand and the supply of resources that results in the at least one metric satisfying the at least one predetermined goal was not found.

4. The method according to claim 1, further comprising:
simulating an operation of the infrastructure in performing the objective without power capping; and
wherein a) further comprises determining the supply of resources based upon the resources required by the infrastructure in performing the objective without power capping.

5. The method according to claim 1, wherein the combination of available resource sources comprises a resource storage device, and wherein b) further comprises simulating operation of the infrastructure using the resource storage device and wherein e) further comprises modifying at least one of a size of the resource storage device and a supply of resources from the resource storage device for the simulation.

6. The method according to claim 1, wherein the combination of available resource sources comprises at least one renewable energy resource source and at least one nonrenewable energy resource source, and wherein e) further comprises modifying the supply of resources to substantially maximize supply of resources from the at least one renewable energy resource source.

7. The method according to claim 1, wherein the plurality of infrastructure components includes a plurality of servers in a server pool, and wherein b) further comprises simulating the operation of the infrastructure by scaling down a central processing unit frequency of at least one of the servers in the server pool whose resource consumption exceeds a predetermined threshold to reduce available resource and capacity available to the at least one of the servers.

8. The method according to claim 1, wherein the plurality of infrastructure components includes a plurality of servers in a server pool, and wherein b) further comprises simulating the operation of the infrastructure by controlling the number of servers in the server pool utilized to perform the objective to cap the total resource demand of the plurality of servers in the server pool.

9. The method according to claim 1, further comprising:
performing b)-e) for a plurality of iterations to determine a mix of the resources supplied and the resource demand that results in a substantially optimized at least one metric.

10. The method according to claim 9, wherein the mix of the resources supplied and the resource demand that results in a substantially optimized at least one metric comprises a mix of the resources supplied and the resource demand that results in a substantially minimized reliance upon resources supplied from nonrenewable resource sources while maximizing performance of the objective by the infrastructure components.

11. The method according to claim 1, wherein b) further comprises simulating the operation of the infrastructure as a function of time.

12. An apparatus for generating a resource management plan for an infrastructure, said apparatus comprising:
at least one module to:
a) determine a supply of resources available from a combination of available resource sources;
b) simulate an operation of the infrastructure in performing an objective using the determined supply of resources, wherein the simulation is to simulate resource demand of a plurality of infrastructure components in performing the objective;
c) determine at least one metric associated with operating the infrastructure based upon the simulation;
d) determining whether the at least one metric satisfies at least one predetermined goal;
e) modify at least one of the resources supplied by the combination of available resource sources and the simulation of the resource demand of the plurality of infrastructure components in response to the at least one metric failing to satisfy the at least one predetermined goal; and
f) generate a resource management plan for the infrastructure that includes a mix of the resources supplied and the resource demand that have been determined to result in the at least one metric satisfying the at least one predetermined goal; and
a processor to implement the at least one module.

13. The apparatus according to claim 12, wherein the at least one module is further to iteratively repeat b)-f) until one of:
a modified mix of the resources supplied and the resource demand that have been determined to result in the at least one metric satisfying the at least one predetermined goal is identified at d); and
a determination that no further modifications are available is made.

14. The apparatus according to claim 12, wherein the at least one module is further to simulate an operation of the infrastructure in performing the objective without power capping and wherein the at least one module is further to determine the supply of resources available from a combination of available resource sources based upon the resources required by the infrastructure in performing the objective without power capping.

15. The apparatus according to claim 12, wherein the combination of available resource sources comprises a resource storage device, and wherein the at least one module is further to simulate operation of the infrastructure using the resource storage device and to modify at least one of a size of the resource storage device and a supply of resources from the resource storage device for the simulation.

16. The apparatus according to claim 12, wherein the combination of available resource sources comprises at least one renewable energy resource source and at least one nonrenewable energy resource source, and wherein the at least one module is further to modify the supply of resources to substantially maximize supply of resources from the at least one renewable energy resource source.

17. The apparatus according to claim 12, wherein the plurality of infrastructure components includes a plurality of servers in a server pool, and wherein the at least one module is further to simulate the operation of the infrastructure by scaling down a central processing unit frequency of at least one of the servers in the server pool whose resource consumption exceeds a predetermined threshold to reduce available resource and capacity available to the at least one of the servers.

18. The apparatus according to claim 12, wherein the plurality of infrastructure components includes a plurality of servers in a server pool, and wherein the at least one module is further to simulate the operation of the infrastructure by controlling the number of servers in the server pool utilized to perform the objective to cap the total resource demand of the plurality of servers in the server pool.

19. The apparatus according to claim 12, wherein the at least one module is further to perform items b)-e) for a plurality of iterations to determine a mix of the resources supplied and the resource demand that results in a substantially optimized at least one metric.

20. A computer readable storage medium on which is embedded at least one computer program, said at least one computer program implementing a method for generating a resource management plan for an infrastructure, said at least one computer program comprising computer readable code to:
determine a supply of resources available from a combination of available resource sources;
simulate an operation of the infrastructure in performing an objective using the determined supply of resources, wherein the simulation is to simulate resource demand of a plurality of infrastructure components in performing the objective;
determine at least one metric associated with operating the infrastructure based upon the simulation;
determine whether the at least one metric satisfies at least one predetermined goal;
modify at least one of the resources supplied by the combination of available resource sources and the simulation of the resource demand of the plurality of infrastructure components in response to the at least one metric failing to satisfy the at least one predetermined goal; and
generate a resource management plan for the infrastructure that includes a mix of the resources supplied and the resource demand that have been determined to result in the at least one metric satisfying the at least one predetermined goal.
